(19) United States
(12) Patent Application Publication
(10) Pub. No.: US 2002/0080279 A1
(43) Pub. Date: Jun. 27, 2002

(54) Enhancing live sports broadcasting with synthetic camera views

(76) Inventors: Sidney Wang, Pleasanton, CA (US); Richter A. Rafey, Santa Clara, CA (US); Hubert Le Van Gong, Santa Clara, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/943,044

(22) Filed: Aug. 29, 2001

Related U.S. Application Data
(60) Provisional application No. 60/228,942, filed on Aug. 29, 2000.

(51) Int. Cl. H04N 9/74

(52) U.S. Cl. 348/584

(57) ABSTRACT

A method for enhancing broadcasts, such as sporting events. In one embodiment, data is received to create a synthetic scene comprising at least one dynamic synthetic object. Data reflective of at least one real dynamic object corresponding to the at least one dynamic synthetic object is also received. A synthetic scene is generated comprising the at least one dynamic synthetic object using data reflective of the at least one corresponding real dynamic object.

This application claims the benefit of U.S. Provisional Application No. 60/228,942, filed Aug. 29, 2000.

### FIELD OF THE INVENTION

The invention relates generally to the enhancement of broadcasts with synthetic camera views generated from the augmenting of video signal content with supplemental data source components.

### BACKGROUND

Modern sports entertainment programming features significant broadcast production enhancements. These enhancements affect both the audio and visual aspects of the coverage. Graphical displays and audio samples and sound bites are routinely employed to enliven a broadcast's production. However these enhancements generally are not directed by the sports viewer at home.

Traditionally, sport viewers at home rely on the television broadcaster to provide them with the best coverage available at any given moment. Functioning as a director, the broadcaster will switch from one camera feed to another depending on the events occurring on the field. With the emergence of DTV (digital television) broadcasting, the broadband viewers may have the opportunity to receive multiple camera feeds and be able to navigate amongst them. Still, the coverage of a sporting event is always limited by the fixed number of cameras set up for the event.

The home viewer is not currently able to choose on field activity on which they would like to focus if this activity is not included in the normal broadcast coverage. As there may be event activity occurring outside of the normal broadcast coverage (or that is made possible by multiple camera feeds), on which the home viewer places significant value, traditional broadcast coverage many times proves inadequate.

### SUMMARY OF THE INVENTION

A method and system for enhancing broadcast coverage of events. In one embodiment, data is received to create a synthetic scene comprising at least one dynamic synthetic object. Data reflective of at least one real dynamic object corresponding to the at least one dynamic synthetic object is also received. A synthetic scene is generated comprising the at least one dynamic synthetic object using data reflective of the at least one corresponding real dynamic object.

### BRIEF DESCRIPTION OF THE DRAWINGS

The present invention is illustrated by way of example and not intended to be limited by the figures of the accompanying drawings in which like references indicate similar elements and in which:

FIG. 1a illustrates one embodiment of an exemplary system in accordance with the teachings of the present invention.

FIG. 1b illustrates one embodiment of an exemplary system in accordance with the teachings of the present invention.

FIG. 1c illustrates an example.

FIG. 2 depicts an exemplary video signal processing system in accordance with the present invention.

FIG. 3 depicts a flowchart illustrating an exemplary process for enhancing broadcasting in accordance with the present invention.

### DETAILED DESCRIPTION

In the following description, for purposes of explanation, numerous details are set forth in order to provide a fair understanding of the present invention. However, it will be apparent to one skilled in the art that these specific details are not required in order to practice the present invention.

The present invention is described in the context of live sports broadcasts. However, the present invention should not be limited as such and is applicable to any kind of video or broadcast, including live and recorded broadcasts and sports broadcasts.

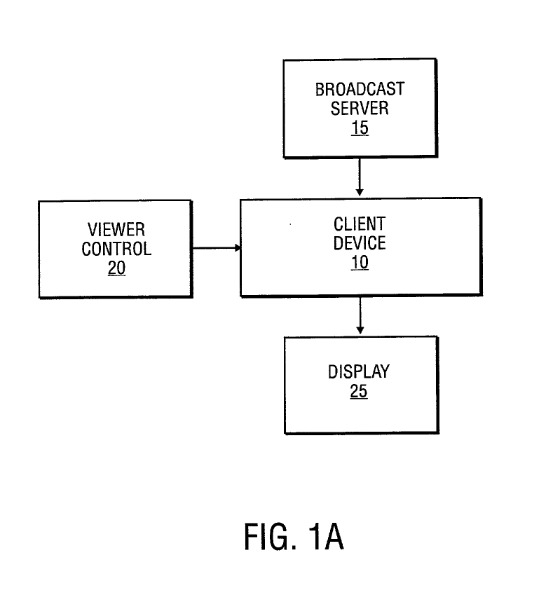

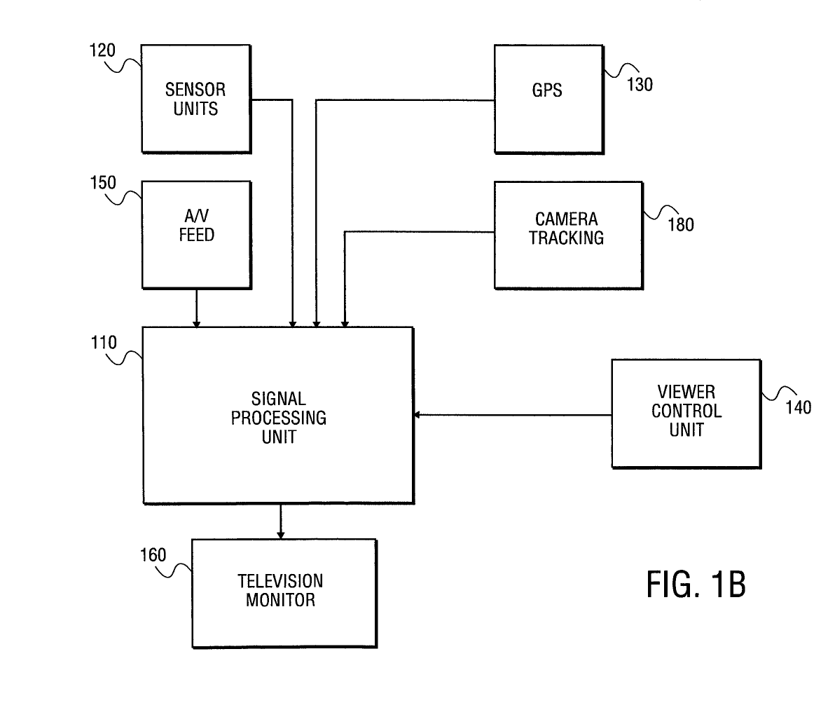

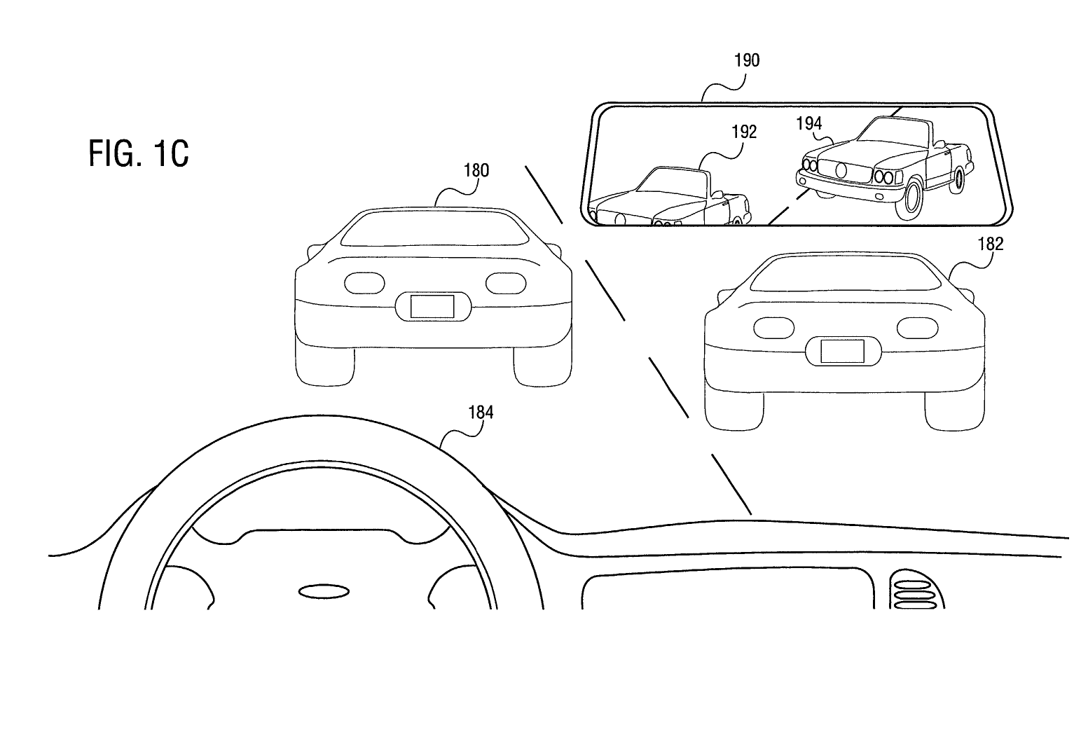

The system of the present invention provides for the enhancement of broadcasts, such as live sports broadcasts, with synthetic camera views. A simplified block diagram of one embodiment of an exemplary system is illustrated in FIG. 1a. Client device 10 is coupled to a broadcast server 15, viewer control 20, and display 25. Broadcast server 15, in this embodiment, provides audio/video (A/V) for display on display device 25 and data for the client device 10 to generate a synthetic scene consisting of at least one dynamic object. For example, using a car race scenario, the server 15 would provide the data to generate a static image of the race track and images of the cars to race on the track. Using the data provided, the client is capable of generating computer graphic images of the track and the cars racing on the track. During the live broadcast, in one embodiment, the broadcast server provides data regarding the position of the cars and the client device uses this data to update the corresponding computer graphic image. The position information can include orientation information to accommodate changes in direction (e.g. due to a spin out) of the vehicle. In alternate embodiments, as is explained below, sensor data may be provided to enhance the synthetic views. For example, sensors may provide information regarding wheel rotation. As a substantial amount of data to generate the synthetic images are provided earlier, the data transmitted is minimal (e.g., position information), thereby permitting real time or near real time generation of synthetic scenes.

The client device 10 may be incorporated into a broadband or broadcast device, including but not limited to, a set top box, personal computer and the like. Alternately, the processes may be performed solely within the server, the resultant images transmitted to the client device 10.

The computer graphic generated images will hereinafter be referred to as the synthetic scene and the objects which form the scene, including the moveable objects, e.g., the cars, will be referred to as the synthetic objects. By using the synthetic scene and objects, synthetic views can be created. A synthetic view is one that is generated based upon synthetic camera tracking data. In one embodiment, the synthetic camera tracking data may mimic the broadcast camera tracking data. In alternate embodiments, the synthetic camera tracking data may differ from the broadcast camera tracking data. In such an embodiment, the field of view and therefore the image provided in the synthetic scene will differ from the broadcast field of view and therefore broadcasted image.

As will be apparent from the discussion below, it is contemplated that the synthetic view may be selected a variety of ways. In the embodiment illustrated by FIG. 1b, the synthetic view may be viewer controlled using the viewer control input 20, which may be a physical control device, such a television remote control, a graphical user interface, and the like. Alternately, the synthetic view may be selected based upon a tracked such that, for example, the tracked object is always in the synthetic view or the synthetic view is always out the rear window of the tracked object. Furthermore, the synthetic view may be identified by the broadcast server 15 and provided to the client device 10. In such an embodiment, control may be automatic or under control of someone producing the corresponding broadcast, e.g., the director or the commentator of the race.

An alternate embodiment of the system of the present invention is illustrated in FIG. 1b. Using camera tracking data, the synthetic scene or objects of the synthetic scene can be integrated or merged with video including live video. For example, statistical or identification information for a certain driver synthetically generated may be placed at a specified position relative to the video image of the car, the synthetic object (i.e., the driver information) would follow along at the same position relative to the location of the car as shown in the video. In alternate embodiments, live video, for example, the view out the front window of a car may be composited with a synthetic view representative of what would be seen in the rear view mirror wherein the synthetic view would be placed at the position of the rear view mirror of the live video. A resultant illustration is provided in FIG. 1C. The vehicles 192, 194 shown in rear view mirror 190 are synthetically generated and composited into the broadcast. Thus, the remaining elements displayed, e.g., vehicles 180, 182, steering column 184, are part of the broadcast image.

Referring to FIG. 1b, the system includes global positioning system (GPS) receiver 130, viewer control unit 140, camera sensor units 120, Audio Visual (A/V) feed 150, signal processing unit 110, and monitor 160.

Signal processing unit 110 receives data inputs from sensor unit 120, A/V data feed 150, GPS receiver 130, viewer control unit 140, and camera tracking unit 180. The signal processing unit 110 processes these live data streams in accordance with data, which may be at least partially provided by viewer control unit 140, along with traditional audio/visual streams, to produce a synthetic camera view enhancement. The synthetic camera shots may be from any desired view positions and angles. The signal processing unit 110 is able to process these various forms of data to present appropriate visual representations on demand. The signal processing unit 110 can be a variety of processing units, including a set top box, game console or a general purpose processing system. The processed signal on which these synthetic camera shots are based is then fed into the monitor 160, which may be a variety of types of displays including a television or computer system display, for display of the synthetic camera shots.

Sensor unit 120 provides sensor data from desired locations. These sensor units are placed in a manner that will facilitate the complimenting of live sport broadcasting with synthetic camera shots with enhanced effects. In one embodiment, the sensor data is fed into the system to facilitate the generation of the synthetic views that may be, in one embodiment, realistic computer generated graphics images. For example, the sensor units 120 may provide data relevant to wheel rotation. Alternately, in other environments sensors may provide data regarding body temperature, pulse and blood pressure wherein the unit 110 would use this information to generate synthetic views that included facial expressions or other body language. The live data streams that are produced by these sensor units are fed into signal processing unit 110.

Global Positioning System (GPS) receiver 130 generates position and orientation data. This data indicates where objects of interest and dynamic or moving objects, such as particular players or cars, are in 3D space. The live position and orientation data produced by the GPS unit facilitates a greater range of production by providing position and orientation data of objects of interest. This data stream is fed into the signal-processing unit for integration with other live data streams. Although a GPS receiver is used herein, it is contemplated that any device that identifies the position of objects of interest may be used.

Camera tracking unit 180 provides camera tracking data. The camera tracking equipment, well known in the art, typically uses encoders to read the current pan, tilt and twist of the camera, as well as the zoom level, i.e., the field of view. This data facilitates the integration of live video with synthetic scenes and objects. The specific data generated may vary according to the equipment used. All or some of the data may be used to integrate video with the synthetic scenes and objects. The integration is achieved by adapting the synthetic scene or object to the generated camera data. By coordinating or registering the 3D-position information of the synthetic scene or object in space with camera tracking information, it is possible to render a synthetic version of a known 3D scene or object in a live video broadcast. In one embodiment, known computer graphic compositing processes are used to combine digital video with the synthetic scenes or objects.

In one embodiment, an audiovisual signal 150 is transmitted from an A/V feed generated by live broadcast camera feeds. The data content of this signal is determined by the broadcaster. This signal is transmitted to the signal-processing unit 110 for integration with the other live data streams. In one embodiment the A/V data is integrated with data from sensor unit 120, GPS unit 130 and camera tracking unit 180 to minimize bandwidth of data transmitted to processing unit 110.

Viewer control unit 140 determines the live view positions and view angles that may be presented. In one embodiment, viewer input controls the processing of the additional data and determines desired synthetic camera view enhancements that may be presented. In one embodiment viewer control is accomplished using a synthetic camera view creating application as it pertains to the generation of desired view positions and view angles. This application module processes camera view creating instructions that control the integration of the supplemental data streams. In one embodiment, viewer control unit 140 controls the fusing of live video and synthetic camera views. In one embodiment these camera view enhancement may be viewer controlled or broadcaster controlled. Thus one may select among camera views, but can also have some views that aren't based on real cameras but follow a particular participant or object.

Viewing monitor 160 presents the live images that are being viewed. These images are based on the signals processed by signal processing unit 110. The images may be composed of the live broadcast, the synthetic scene corresponding to the live broadcast or a combination of the two. In addition, in some embodiments, the viewing monitor displays a GUI that enables a viewer to control what is displayed. In one embodiment, this signal is transmitted to the monitor by means of a presentation engine, which resides in the monitor or a separate unit, for example a set top box, game console or other device (not shown).

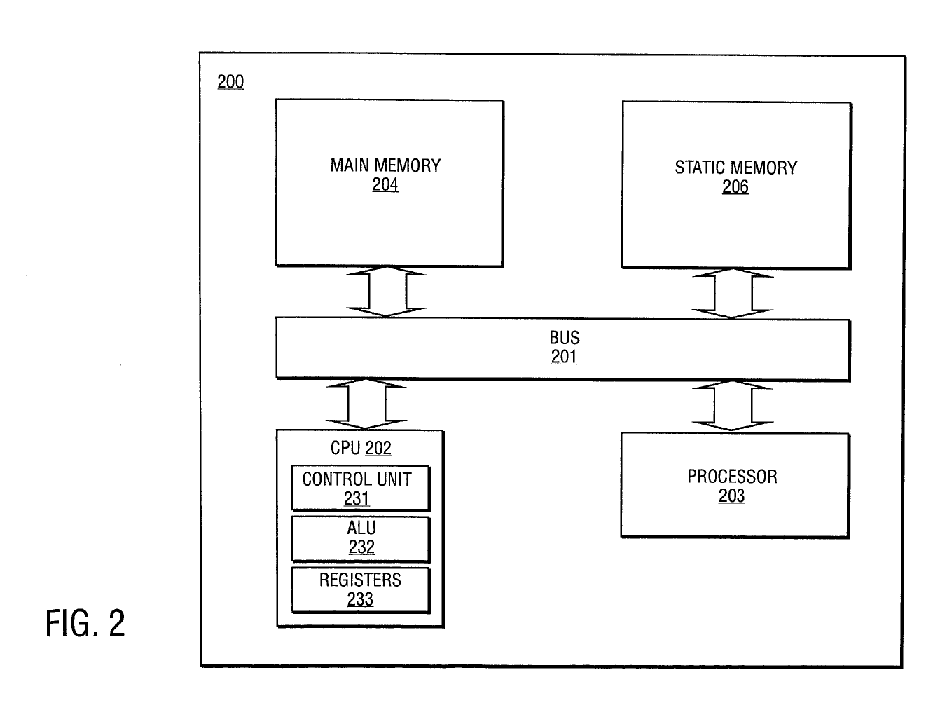

FIG. 2 depicts an exemplary video signal processing system 200 with which the present invention may be implemented. In one embodiment, the synthetic camera view enhancing techniques may be implemented based on a general processing architecture. Referring to FIG. 2, processing system 200 includes a bus 201 or other communications means for communicating information, and central processing unit (CPU) 202 coupled with bus 201 for processing information. CPU 202 includes a control unit 231, an arithmetic logic unit (ALU) 232, and several registers 233. For example, registers 233 may include predicate registers, spill and fill registers, loading point registers, integer registers, general registers, and other like registers. CPU 202 can be used to implement the synthetic camera view enhancing instructions described herein. Furthermore, another processor 203 such as, for example, a coprocessor can be coupled to bus 201 for additional processing power and speed.

Signal Processing system 200 also includes a main memory 204, which may be a Random Access Memory (RAM) or some other dynamic storage device that is coupled to bus 201. Main memory 204 may store information and instructions to be executed by CPU 202. Main memory 204 may also store temporary variables or other intermediate information during execution of instructions by CPU 202. Processing system 200 may also include a static memory 206 such as, for example, a Read Only Memory (ROM) and /our other static source device that is coupled to bus 201 for storing static information and instructions for CPU 202. A mass storage device 207, which may be a hard or floppy disk drive, CD ROM or tape, can also be coupled to bus 201 for storing information and instructions.

Computer readable instructions may be provided to the processor to direct the processor to execute a series of synthetic camera view-creating instructions that correspond to the generation of a desired synthetic camera views or scenes. A display device, such as a television monitor, displays the images based on the synthetic camera views created by the instructions executed by processor 202. In one embodiment, the displayed images correspond to the particular sequence of computer readable instructions that coincide with the synthetic view selections.

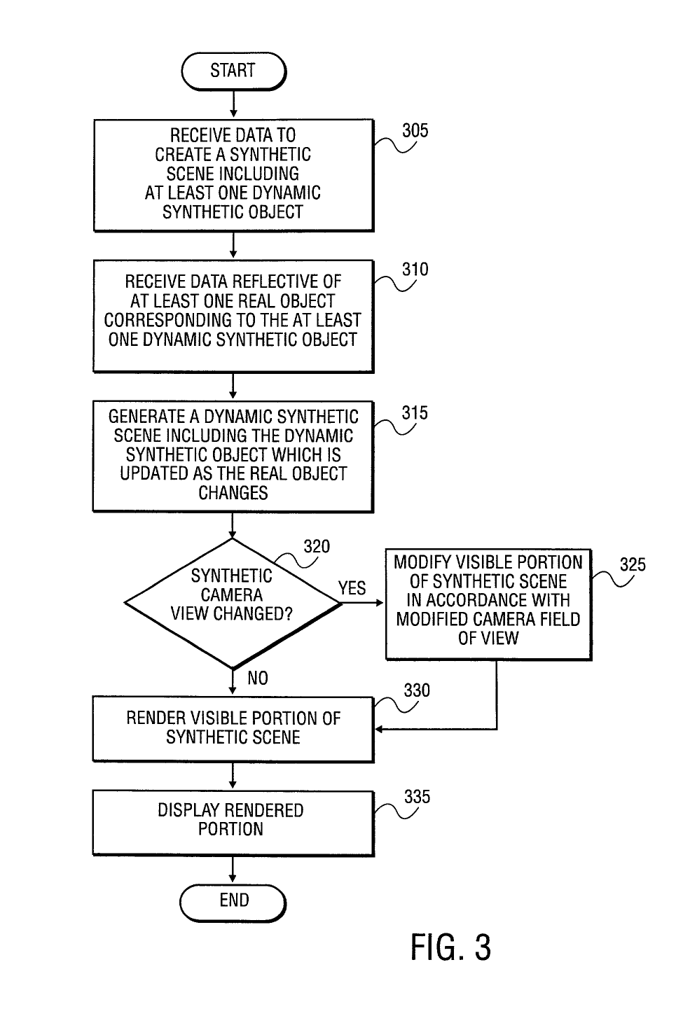

FIG. 3 illustrates an exemplary process performed to generate dynamic synthetic objects used to enhance broadcasts. At step 305, the client device, for example the set top box at the viewer's location, receives data to create a synthetic scene comprising at least one dynamic object. The synthetic scene, in the present embodiment, is composed of a three dimensional computer graphic representation of the scene represented. Continuing with the race track example referred to above, the synthetic scene generated may be a computer graphic representation of a static synthetic object, i.e., the track with the computer graphic representations of the dynamic synthetic objects, e.g., the race cars, located on the track. In one embodiment, this information is received from a server, such as one operated by the broadcast/broadband service supplying the broadcast of the race. This information is preferably transmitted prior to the activity of interest, e.g., the race, such that the client device generates the synthetic scene corresponding to the activity of interest. It is readily apparent that this information may be supplied, not only over the service provider's media, but over a variety of media including the Internet.

Once the activity of interest starts, the service provider provides, step 310, data relevant to real objects corresponding to the synthetic objects. In one embodiment, position data of each race car, acquired from GPS receivers located on each car and provided to the server, is sent to the client device and the synthetic scene is updated, step 315, with respect to the corresponding synthetic object (i.e., the car). Thus the position of the synthetic representation of the car moves as the position of the corresponding real car moves. As noted, other data, such as wheel rotation, may also be provided to update the corresponding synthetic object. It should be realized that as the amount of the data to be transmitted to the client to update the synthetic scene is minimized, perceived real time or near real time updates are achieved.

The synthetic scene displayed is determined according to a synthetic camera view. The synthetic camera view may be one determined by the broadcast, by the viewer, or other control mechanism. For example, the viewer may indicate that the synthetic camera is to follow a certain driver. Thus the synthetic view will have a field of view that centers on that certain driver. Alternately, the synthetic camera view is matched to the real camera view using the camera tracking data. This enables the combining or compositing of real images and synthetic images which includes all or a portion of a real (e.g., broadcast) image and a synthetic image (e.g. synthetic object).

Continuing with reference to FIG. 3, at step 320, it is determined whether the synthetic camera view has changed from a prior setting, for example, from the prior rendering or since a predetermined time frame. If the synthetic camera view has changed, at step 325 the visible portion of the synthetic scene is modified to correspond with the updated field of view of the synthetic camera.

At step 330, the visible portion of the synthetic scene is rendered and displayed, step 335, to the viewer. The synthetic scene may be displayed to the viewer a variety of ways. For example, the synthetic scene from a selected view may be display within a predefined area on the display which may be, for example, overlay a portion or be adjacent to a display of the live broadcast. Alternately, only the synthetic scene is displayed or toggling between the live broadcast and the synthetic scene is performed.

As noted earlier, the synthetic views generated may be utilized a variety of ways. In one embodiment, the synthetic views utilized are controlled by the user. In other embodiments, synthetic views are merged with live video to generate composited images of the synthetic view and live broadcast.

The present invention may be utilized in a variety of environments. For example, in motorsports, in-car footage is often shown during broadcast. However, this camera view only provides actions that occur in front of the car. With a synthetic rearview camera shot mapped into a virtual rear-view mirror or metaphor of the live video footage, viewers can also visualize actions occurring behind the car of interest.

Furthermore, some telecast sports are showing actions seen from the perspective of players or umpires on the field. However, it is usually not possible for the viewers at home to receive all the A/V streams from all players. Thus, viewers are not able to freely choose the in-player camera view from the player of their choice. The process according to one embodiment of the present invention can generate synthetic camera views from a variety of positions and angles. In this way, in-player views from any player can be produced. Similar to the in-player view, it is contemplated that one may be able to create synthetic camera views from the viewpoint of a baseball, football, etc. The views obtained by such camera shots give viewers a new perspective when watching a sporting event.

In addition, a motorsport fan might want to follow his favorite driver throughout the race. However, most likely this driver will not be covered by the live broadcast for the entire race duration. Upon a viewer's request, the system of the present invention may display a synthetic camera rendering that focuses at all times on the desired driver.

In some embodiments, a high degree of sensor data is broadcast along with the traditional A/V streams. In one embodiment, the sensor data may contain the position data for the critical elements (e.g. players, cars) in the sporting events. Other types of sensor data may also be provided. For example, to achieve more realistic synthetic camera shots, a higher degree of sensor data tracking the orientation of a car, the movement of players' arms and legs, medical data, e.g. pulse, blood pressure and environmental conditions may be used.

In the foregoing specification, the invention has been described with reference to specific exemplary embodiments thereof. It will, however, be evident that various modifications and changes may be made there to without departing from the broadest spirit and scope of the invention as set forth in the attendant claims. The specifications and drawings are accordingly to be regarded in an illustrative sense rather than in a restrictive sense.

What is claimed is:

1. A method comprising:
receiving data to create a synthetic scene comprising at least one dynamic synthetic object;
receiving data reflective of at least one real dynamic object corresponding to the at least one dynamic synthetic object; and
generating a synthetic scene comprising the at least one dynamic synthetic object using data reflective of the at least one corresponding real dynamic object.

2. The method as set forth in claim 1, further comprising combining the at least one synthetic object with a live broadcast such that the synthetic object appears at least a part of the broadcast.

3. The method as set forth in claim 1, further comprising specifying a synthetic camera including a synthetic field of view of the synthetic camera, said generating comprising displaying the synthetic scene within the synthetic field of view.

4. The method as set forth in claim 3, wherein the synthetic field of view is set according to a criteria selected from the group consisting of following a position of the at least one real dynamic object, specification by a viewer, correspondence to a field of view of a real camera.

5. The method as set forth in claim 3, wherein the data reflective of the at least one corresponding real dynamic object comprises position information of the real dynamic object.

6. The method as set forth in claim 3, wherein the synthetic scene corresponds to a one of live or recorded audio/visual (A/V) data.

7. The method as set forth in claim 6, wherein the A/V data comprises a broadcast.

8. The method as set forth in claim 6, wherein the synthetic camera is specified to correspond to a real camera of the A/N data.

9. The method as set forth in claim 1, further comprising:
setting a synthetic field of view to correspond to a field of view of a real camera recording real images;
combining the synthetic scene within the synthetic field of view with real images within the field of view of the real camera.

10. A client device comprising:
a first input coupled to receive data to create a synthetic scene comprising at least one dynamic synthetic object;
a second input coupled to receive data reflective of at least one dynamic real object corresponding to the at least one dynamic synthetic object; and
a processing device configured togenerate a synthetic scene comprising the at least one dynamic synthetic object using data reflective of the at least one corresponding dynamic real object.

11. The client device as set forth in claim 10, wherein the processor is further configured to combine the at least one synthetic object with a live broadcast such that the synthetic object appears at least a part of the broadcast.

12. The client device as set forth in claim 10, further comprising specifying a synthetic camera including a synthetic field of view of the synthetic camera, said generating comprising displaying the synthetic scene within the synthetic field of view.

13. The client device as set forth in claim 12, wherein the synthetic field of view is set according to a criteria selected from the group consisting of following a position of the at least one real dynamic object, specification by a viewer, correspondence to a field of view of a real camera.

14. The client device as set forth in claim 10, wherein the data reflective of the at least one corresponding real dynamic object comprises position information of the real dynamic object.

15. The client device as set forth in claim 12, wherein the synthetic scene corresponds to a one of live or recorded audio/visual (A/V) data.

16. The client device as set forth in claim 15, wherein the A/V data comprises a broadcast.

17. The client device as set forth in claim 15, wherein the synthetic camera is specified to correspond to a real camera of the A/V data.

18. The client device as set forth in claim 10, wherein the processor is further configured to set a synthetic field of view to correspond to a field of view of a real camera recording real images and combine the synthetic scene within the synthetic field of view with real images within the field of view of the real camera.

19. The client device as set forth in claim 10, wherein the client device is selected from the group consisting of a signal processor, general purpose processor, set top box and video game console.

20. A system comprising:
a broadcast server configured to provide data to create a synthetic scene comprising at least one dynamic synthetic object, data reflective of at least one dynamic real object corresponding to the at least one dynamic synthetic object;
a client device coupled to the broadcast server, said device receiving data to create a synthetic scene comprising at least one dynamic synthetic object, receiving data reflective of at least one real dynamic object corresponding to the at least one dynamic synthetic object, and generating a synthetic scene comprising the at least one dynamic synthetic object using data reflective of the at least one corresponding real dynamic object.

21. The system as set forth in claim 20, said broadcast server further configured to provide a live broadcast, said client device further configured to combine at least a portion of the synthetic scene with the live broadcast.

22. The system as set forth in claim 21, further comprising specifying a synthetic camera including a synthetic field of view of the synthetic camera, said client device displaying the synthetic scene within the synthetic field of view.

23. The system as set forth in claim 22, wherein the synthetic field of view is set according to a criteria selected from the group consisting of following a position of the at least one real dynamic object, specification by a viewer at the client device, correspondence to a field of view of a real camera coupled to the broadcast server.

24. The system as set forth in claim 21, wherein the data reflective of the at least one corresponding real dynamic object comprises position information of the real dynamic object.

25. The system as set forth in claim 24, wherein the position information is communicated frequently from the broadcast server to the client device such the synthetic scene comprising the at least one dynamic synthetic object is frequently updated to correspond to the corresponding dynamic real object.

26. The system as set forth in claim 22, wherein the processor is further configured to set a synthetic field of view to correspond to a field of view of a real camera recording real images and combine the synthetic scene within the synthetic field of view with real images within the field of view of the real camera.

27. The client device as set forth in claim 20, wherein the client device is selected from the group consisting of a signal processor, general purpose processor, set top box and video game console.

28. A broadcast device a configured to provide data to create a synthetic scene comprising at least one dynamic synthetic object, data reflective of at least one dynamic real object corresponding to the at least one dynamic synthetic object; wherein a synthetic scene comprising the at least one dynamic synthetic object using data reflective of the at least one corresponding real dynamic object is generated.

29. The broadcast device as set forth in claim 28, said broadcast device further configured to provide a live broadcast, wherein at least a portion of the synthetic scene is combined with the live broadcast.

30. The broadcast device as set forth in claim 28, said broadcast device further configured to specify a synthetic camera including a synthetic field of view of the synthetic camera, wherein the synthetic scene is displayed within the synthetic field of view.

31. The broadcast device as set forth in claim 30, wherein the synthetic field of view is set according to a criteria selected from the group consisting of following a position of the at least one real dynamic object, specification by a viewer at the client device, correspondence to a field of view of a real camera coupled to the broadcast server.

32. The broadcast device as set forth in claim 28, wherein the data reflective of the at least one corresponding real dynamic object comprises position information of the real dynamic object.

33. The broadcast device as set forth in claim 32, wherein the position information is updated frequently such the synthetic scene comprising the at least one dynamic synthetic object is frequently updated to correspond to the corresponding dynamic real object.

34. The broadcast device as set forth in claim 29, said broadcast device further configured to set a synthetic field of view to correspond to a field of view of a real camera recording the live broadcast and combine the synthetic scene within the synthetic field of view with real images within the field of view of the real camera.
